(19) United States
(12) Patent Application Publication
(10) Pub. No.: US 2014/0119897 A1
(43) Pub. Date: May 1, 2014

(54) Hydroturbine Guide Vanes and Hydroturbine

(71) Applicant: Hitachi, Ltd., Tokyo (JP)

(72) Inventor: Takanori ISHII, Tokyo (JP)

(73) Assignee: Hitachi, Ltd., Tokyo (JP)

(21) Appl. No.: 14/062,538

(22) Filed: Oct. 24, 2013

(30) Foreign Application Priority Data
Oct. 25, 2012 (JP) 2012-235456

(51) Int. Cl. F03B 3/18

(52) U.S. Cl. CPC F03B 3/183
USPC 415/159; 415/71

(57) ABSTRACT

The invention provides hydroturbine guide vanes and a hydroturbine which are capable of achieving high efficiency in a Francis turbine having a low flow rate at the highest efficiency point according to the specifications thereof and, in addition, hardly present a strength problem when regulating the flow rate. The guide vanes includes a plurality of fixed guide vanes having a long chord length and a plurality of movable guide vanes having a short chord length arranged between the fixed guide vanes, and a flow rate regulation including a fully-closed state is performed by rotating the movable guide vanes having the short chord length.

### CLAIM OF PRIORITY

The present application claims priority from Japanese Patent application serial no. 2012-235456, filed on Oct. 25, 2012, the content of which is hereby incorporated by reference into this application.

### BACKGROUND OF THE INVENTION

1. Technical Field

The present invention relates to hydroturbine guide vanes and a hydroturbine.

2. Description of the Related Art

In a Francis Turbine, a flow going into a hydroturbine passes between stay vanes and guide vanes while flowing along the interior of a spiral casing and is provided with a swirl motion in the direction of rotation of a runner. Then, the flow goes into flow channels between runner vanes of the rotating runner, so that the energy of a swirl flow is collected as a motive power, flows downstream of the runner via a draft tube, and is discharged as a flow without the swirl motion.

One of important performance benchmarks required for the hydroturbine is efficiency. A factor which significantly affects the hydroturbine efficiency is a runner, and the runner is designed to have a shape achieving the highest efficiency for given design specifications. The conditions of the flow flowing into the runner are determined by the shapes of a spiral casing, stay vanes, and guide vanes when the design specification is determined. Therefore, the efficiency of the entire hydroturbine may be improved by setting these elements to have the shapes which increase the efficiency of the runner.

The guide vanes have a role of guiding the flow into a runner inlet at an adequate angle and, simultaneously, regulating the flow rate, and are configured as movable vanes which are openable and closable. The guide vanes need to be capable of achieving a fully-closed state in which the flow from upstream is completely blocked by closing the vanes.

In the related art, various types of the guide vanes are studied. For example, there are guide vanes disclosed in JP-A-54-137532 and JP-A-2004-353570.

In JP-A-54-137532, a structure in which half of movable guide vanes are replaced with fixed members alternately in order to improve an operation performance at the time of a light-load operation, reduce the weight of a hydroturbine upper cover, and halve the components of a guide vane operating mechanism is proposed. In JP-A-54-137532, a structure in which the movable guide vanes are arranged between stay vanes having the fixed members integrally therewith is also proposed.

In JP-A-2004-353570, a structure in which guide vanes include long guide vanes and short guide vanes, and the short guide vanes are respectively arranged so as to be interposed respectively between the long guide vanes in order to suppress a swirl loss generated in the guide vanes in a low-flow area at the time of pump operation of a pump hydroturbine, and improve an unstable positively sloped head-flow characteristics caused thereby is proposed.

As a hydroturbine used in an area of small flow rate and high head, a Pelton turbine is mainly used in the related art, and the Francis turbine is not much used. In the area of small flow and high head, the Francis turbine needs improvement of performances.

The flow in the hydroturbine is characterized by three parameters: number of rotations of the hydroturbine, the head, and the flow rate. The hydroturbine needs to be a state in which the flow goes smoothly along the vanes at the highest efficiency point requiring the highest efficiency. However, the adequate vane shape changes significantly depending on the combination of the number of rotations of the hydroturbine, the head, and the flow rate. Among the flowing conditions of these three parameters, the shape of the guide vanes is significantly affected by the flow rate.

According to the study of the inventor, under the condition that the flow rate is low, the flowing angle at outlets of the guide vanes (the angle of the flow formed with respect to a circle having a center at a rotating shaft of the hydroturbine) needs to be reduced and, at this time, since the thickness of the vanes significantly affects an effective flow channel width between the guide vanes, the thickness of the guide vanes need to be reduced to uniformize the flow at the inlet of the runner (described in detail later).

In contrast, since a function to regulate the flow rate is required for the guide vanes, a fully-closed state needs to be realized by changing the width of the flow channels by rotating the guide vanes. However, rotating thin and long vanes is not desirable in terms of strength because deformation of the vanes may result due to a force applied by the flow.

In the related art including JP-A-54-137532 and JP-A-2004-353570, the shape of the guide vanes of the Francis turbine having a low flow rate at the highest efficiency point according to the specifications thereof is not reviewed.

### SUMMARY

It is an object of the invention to provide hydroturbine guide vanes and a hydroturbine which are capable of achieving high efficiency in a Francis turbine having a low flow rate at the highest efficiency point according to the specifications thereof and, in addition, hardly present a strength problem when regulating the flow rate.

In the invention, guide vanes includes a plurality of fixed guide vanes having a long chord length and a plurality of movable guide vanes having a short chord length arranged between the fixed guide vanes, and wherein a flow rate regulation including a fully-closed state is performed by rotating the movable guide vanes having the short chord length.

According to the invention, since the chord length of the guide vanes to be rotated is relatively shorter in comparison with the thickness thereof, the bending strength is higher than a case where the chord length is long, so that the strength problem with respect to the rotation may be avoided. Consequently, in the hydroturbine having a low flow rate at the highest efficiency point according to the specifications thereof, guide vanes having a small thickness maybe used while suppressing occurrence of the strength problem at the time of flow rate regulation and a flow at the inlet of the runner is uniformized, and hence high efficiency may be realized.

Problems, configurations, and effects other than those described above will be apparent by a description of Examples described below.

### BRIEF DESCRIPTION OF THE DRAWINGS

FIG. 1 is a plan view of an example of a hydroturbine to which guide vanes of an example of the invention are applied;

FIG. 2 is a meridional cross-section of an example of the hydroturbine to which the example of the invention is applied;

FIG. 3 is a plan view illustrating hydroturbine vanes including the guide vanes reviewed in a course of achieving the invention;

FIG. 4 is a plan view illustrating another hydroturbine vanes including the guide vanes reviewed in the course of achieving the invention;

FIG. 5 is an explanatory drawing illustrating a fully-closed state of the guide vanes of the example of the invention;

FIG. 6 is a plan view of the hydroturbine vanes including the guide vanes of another example of the invention;

FIG. 7 is an explanatory drawing illustrating the fully-closed state of the guide vanes of another example of the invention; and

FIG. 8 is a partly enlarged plan view of the hydroturbine vanes including the guide vanes of another example of the invention.

### DESCRIPTION OF THE PREFERRED EMBODIMENTS

Referring now to the drawings, examples of the invention will be described.

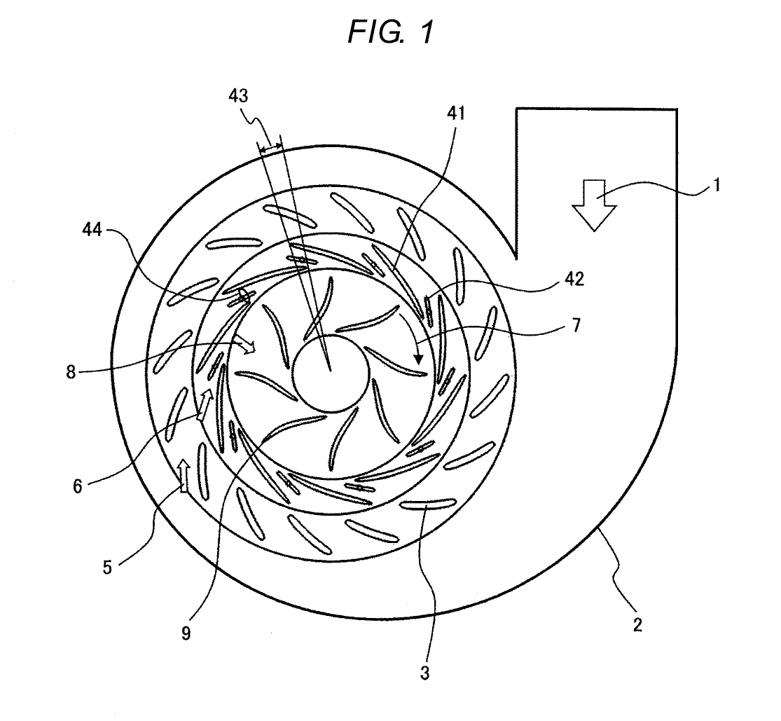

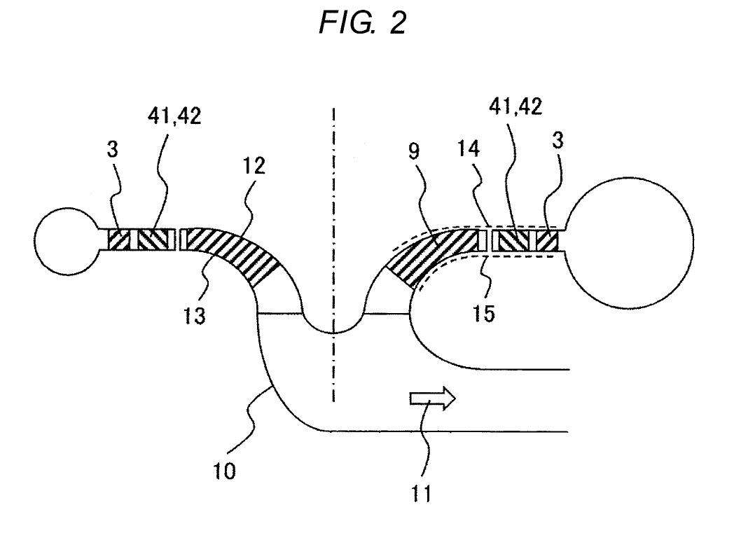

First of all, a hydroturbine to which guide vanes of the invention are applied will be described with reference to FIG. 1 and FIG. 2. FIG. 1 illustrates entire hydroturbine vanes, and FIG. 2 illustrates a meridional cross-sectional shape thereof.

A flow 1 coming from upstream flows along the interior of a spiral casing 2, passes between stay vanes 3, guide vanes 41 and 42 (detailed configuration will be described later) (in the direction indicated by arrows 5 and 6 in FIG. 1), and is provided with a swirl motion in a runner rotating direction 7. A flow 8 between runner vanes 9 flows into flow channels between the runner vanes 9, whereby turning energy thereof is collected as a motive power. The flow going down between the runner vanes 9 passes through a draft tube 10 in FIG. 2, and is discharged as a flow 11 flowing downstream without the swirl motion. The runner vanes 9 are fixed to a crown 12 at upper portions thereof and to a shroud 13 at lower portions thereof. An upper side of the stay vanes, the guide vanes, and a runner is referred to as a crown side 14, and a lower side thereof is referred to as a shroud side 15.

The stay vanes are structure members of the hydroturbine, and are fixed to the crown side 14 at upper portions thereof, and to the shroud side 15 at lower portions thereof via a speed ring (not illustrated).

The guide vanes have a role of guiding the flow into a runner inlet at an adequate angle and regulating the flow rate, and are configured as movable vanes which are openable and closable. The guide vanes need to be capable of achieving a fully-closed state in which the flow from upstream is completely blocked by closing the vanes.

Subsequently, the way that the invention is achieved will be described.

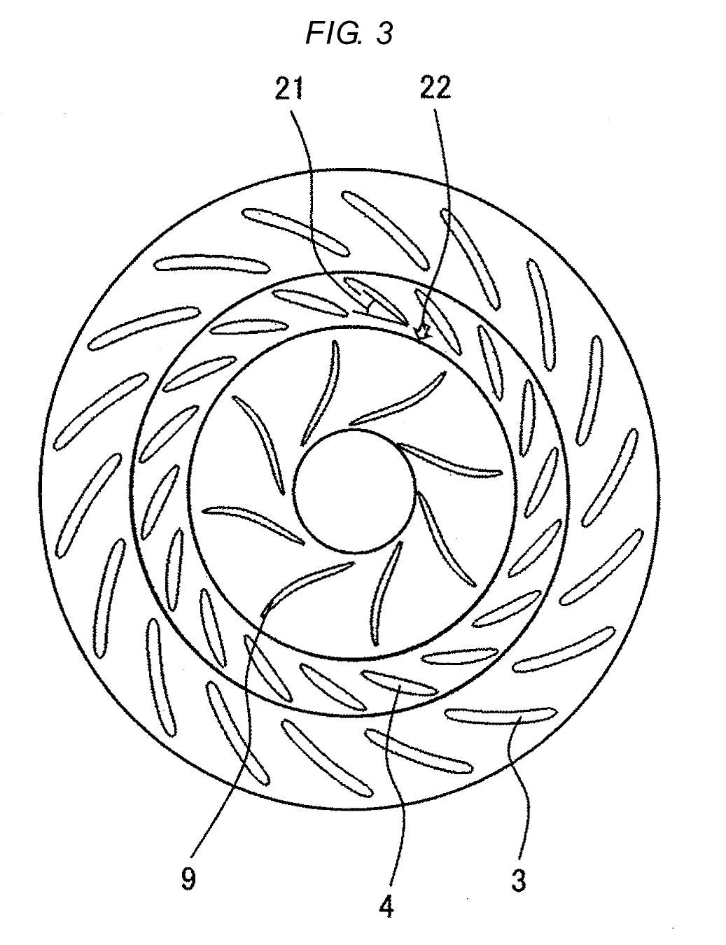

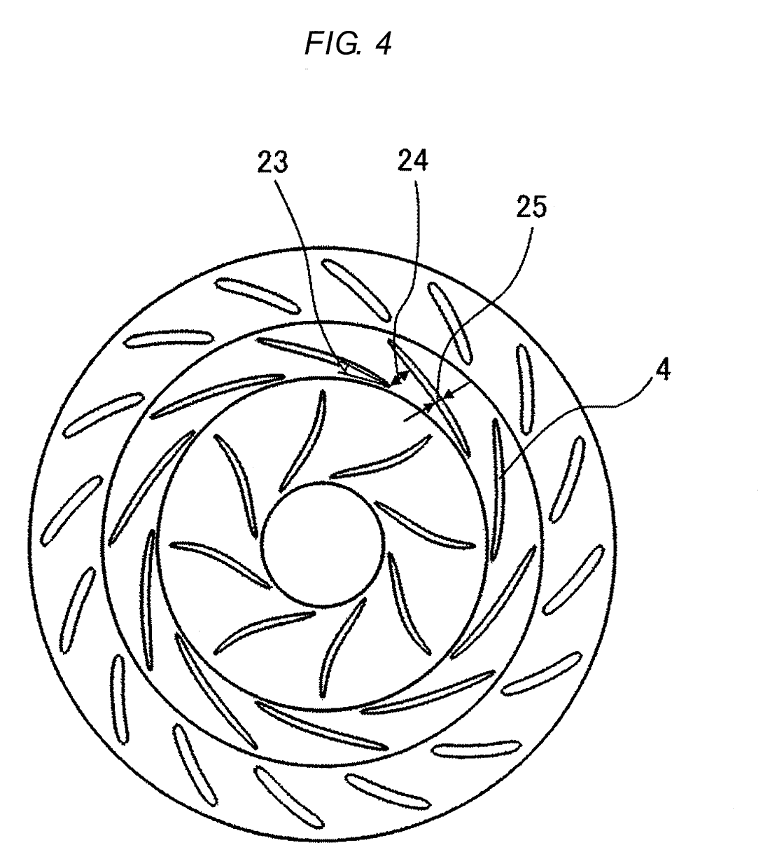

FIG. 3 and FIG. 4 are plan views illustrating hydroturbine vanes including the guide vanes reviewed in a course of achieving the invention. One of characteristics of the shape of the guide vane is a guide vane outlet angle 21 illustrated in FIG. 3. The guide vane outlet angle 21 is an angle 21 of a camberline defined by intermediate points of vane surfaces on both sides of the guide vane formed with a tangential line of a circle having a center at a rotating shaft of the hydroturbine. Since the flow goes along the guide vanes in the vicinity of outlets of the guide vanes, the guide vane outlet angle corresponds also to an angle of the flow at the outlets of the guide vanes formed with respect to the tangential lines of the circle having the center at the rotating shaft of the hydroturbine.

Under the conditions that the flow rate is low, a flow velocity component 22 of the flow in the direction toward the rotating shaft of the hydroturbine is reduced. Therefore, the angle formed between the flow and the tangential line of the circle having the center at the rotating shaft of the hydroturbine (hereinafter, referred to as “angle of flow”) is reduced. Therefore, in order to enhance the efficiency with the hydroturbine having a low flow rate at the highest efficiency point according to the specifications thereof, the guide vane outlet angle needs to be smaller than the guide vane outlet angle 21 illustrated in FIG. 3 as a guide vane outlet angle 23 illustrated in FIG. 4.

When the flow rate is low at the highest efficiency point of the hydroturbine, the guide vane outlet angle needs to be small and, in addition, the flow going into the runner needs to be as uniform as possible simultaneously in order to enhance the efficiency of the hydroturbine as much as possible (uniformization of the flow velocity distribution at the outlets of the guide vanes is required). The uniformity of the flow to the runner is determined by the relationship between a flow channel width 24 between the guide vanes and a guide vane thickness 25, and the smaller the guide vane thickness 25 with respect to the flow channel width 24, the more the flow is uniformized. However, since the flow channel width 24 between the guide vanes is reduced with reduction of the flow rate, the guide vane thickness 25 in FIG. 4 having a low flow rate specification needs to be smaller than the guide vane thickness in FIG. 3 in order to maintain the uniformity of the flow into the runner. Furthermore, since the guide vanes need to form a fully closed state by rotating the vanes, when the same number of vanes is used, the chord length cannot be reduced. Therefore, if the thickness of the vanes is reduced, the thickness with respect to the length is relatively reduced, so that the vanes are formed into a relatively elongated shape. A reduction of the chord length by increasing the number of the vanes is also conceivable. However, when considering a moving mechanism of the guide vane, an increase of the number of the vanes is not recommended. In other words, in the hydroturbine having a low flow rate at the highest efficiency point according to the specifications thereof, the thickness of the guide vane needs to be reduced and the chord length needs to be increased in order to enhance the efficiency of the hydroturbine.

In contrast, since a function to regulate the flow rate is required for the guide vanes, a fully-closed state needs to be realized by changing the width of the flow channels by rotating the guide vanes. However, rotating the thin and long vanes is not desirable in terms of strength because deformation of the vanes may result due to a force applied by the flow.

Therefore, in order to achieve high efficiency with the hydroturbine having a small flow rate at the highest efficiency point according to the specifications thereof, thin and long guide vanes having a flow rate regulating mechanism which does not cause the strength problem are required.

In the invention, for example, the guide vanes composed of thin vanes having different lengths arranged alternately as the guide vanes, in which only the short vanes among the guide vanes are movable are used as illustrated in FIG. 1. The long vanes are used as fixed vanes and only the short vanes are rotated for regulating the flow rate. Since the long vanes are the fixed vanes, the strength problem in association with the flow rate regulation does not occur even when being formed to have a thin profile. In contrast, since the short vanes are rotated, and the length of the vanes to be rotated is relatively short with respect to the thickness, the bending strength is higher than that of the long vanes, and hence the strength problem with respect to the rotation may be avoided. In other words, in order to maintain the uniformity of the flow to the runner, the thickness reduction may be applied to all of the vanes.

With the guide vanes in this configuration, even with the low flow rate specification, uniformization of the flow at the runner inlet and the flow rate regulating function of the guide vanes may be realized simultaneously without causing the strength problem, so that the efficiency of the hydroturbine may be enhanced.

In FIG. 4 of JP-A-54-137532, a structure in which movable guide vanes are arranged between the stay vanes having fixed members integrally therewith, which is a structure similar to that of the invention on the surface is prima facie described. However, in the invention, the stay vanes and the guide vanes are installed separately (the stay vanes are installed aside from the guide vanes), unlike the structure in JP-A-54-137532. Since the stay vanes and the guide vanes have different roles, it is desirable to install these vanes separately, and the invention is based on the premise that the stay vanes and the guide vanes are installed separately.

In other words, the flow coming from the spiral casing has a non-uniform flow rate distribution from an incoming portion to an end of the spiral. However, in order to enhance the efficiency of the runner, the flow entering into the runner is preferably uniform in the circumferential direction. Therefore, the stay vanes have a role to uniformize the distribution of the flow from the spiral casing in the circumferential direction as much as possible, and rectify the flow so that the inflow angle into the guide vanes become constant in the circumferential direction. In contrast, in order to realize the fully-closed state, the guide vanes need to be arranged in a periodical pattern in the circumferential direction. Therefore, removal of the non-uniformity of the flow in the circumferential direction by the guide vanes is limited. Since the stay vanes are the fixed member and hence have flexibility in shape, the stay vanes are capable of further uniformizing the flow by changing the shape of the vanes according to the distribution of the flowing field in the circumferential direction in order to rectify the non-uniform flow coming from the spiral casing. Therefore, in the invention, the guide vanes and the stay vanes are installed separately and the object of the invention is achieved only by the guide vanes, so that such an event that the stay vanes and the guide vanes cannot play respective roles sufficiently because the parts of the stay vanes and the guide vanes are integrally formed is avoided.

### EXAMPLE 1

Example 1 of the invention is illustrated in FIG. 1. The guide vanes are composed of two types of vanes having different chord lengths (the fixed guide vanes 41 and the movable guide vanes 42) and, in addition, these vanes are arranged alternately and only the short vanes are configured to be movable. In order to achieve high efficiency in the low flow rate condition, the thickness of the fixed guide vanes and the movable guide vanes is small, and also the guide vane outlet angle is small, so that the angle of the flow at the outlets of the guide vanes becomes small and the flow at the outlets of the guide vanes becomes uniform.

Furthermore, in Example 1, two of the fixed guide vanes 41 adjacent to each other and having a long chord length are arranged at a high density in the circumferential direction so as to generate overlapped areas 43 when viewing in areas of the rotational angle around the rotation axis of the hydroturbine. The reason why the fixed guide vanes 41 are arranged so that the overlapped areas 43 are generated is for forming the flow channels between the fixed guide vanes 41 and the movable guide vanes 42. From the view point that the guide vanes are closed completely, the overlapped areas 43 are not necessarily formed between the fixed guide vanes as long as the overlapped areas 43 are formed between the fixed guide vanes 41 and the movable guide vanes 42. However, if the fixed guide vanes are short, the flow channels having a sufficient length are not formed between the inlet side of the fixed guide vanes 41 and the movable guide vanes 42, and hence it is difficult to deflect the flow in order to guide the flow to the runner. Therefore in Example 1, the fixed guide vanes 41 are configured to generate the overlapped areas 43 between the fixed guide vanes 41, so that the flow channels having a sufficient length are formed between the inlet side of the fixed guide vanes 41 and the movable guide vanes 42.

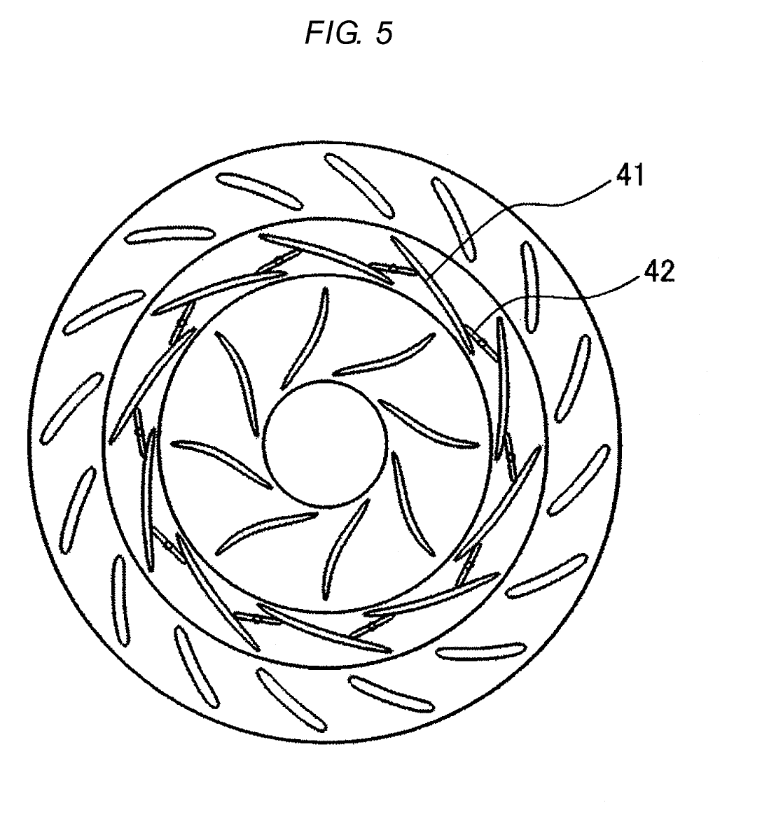

The movable guide vanes 42 having a short chord length are installed in the vicinity of areas 44 where the distance between the vanes is a minimum between the fixed guide vanes 41 having a long chord length. The fully-closed state of the flow channels as illustrated in FIG. 5 is realized by rotating the movable guide vanes 42.

The movable guide vanes 42 having the short chord length are characterized in that the thickness thereof is as thin as that of the fixed guide vanes 41 having the long chord length, but the length is significantly shorter. Therefore, even when the vanes are rotated in a state in which a pressure from the flow is applied thereto, the strength problem such as a deformation of the vanes does not occur.

### EXAMPLE 2

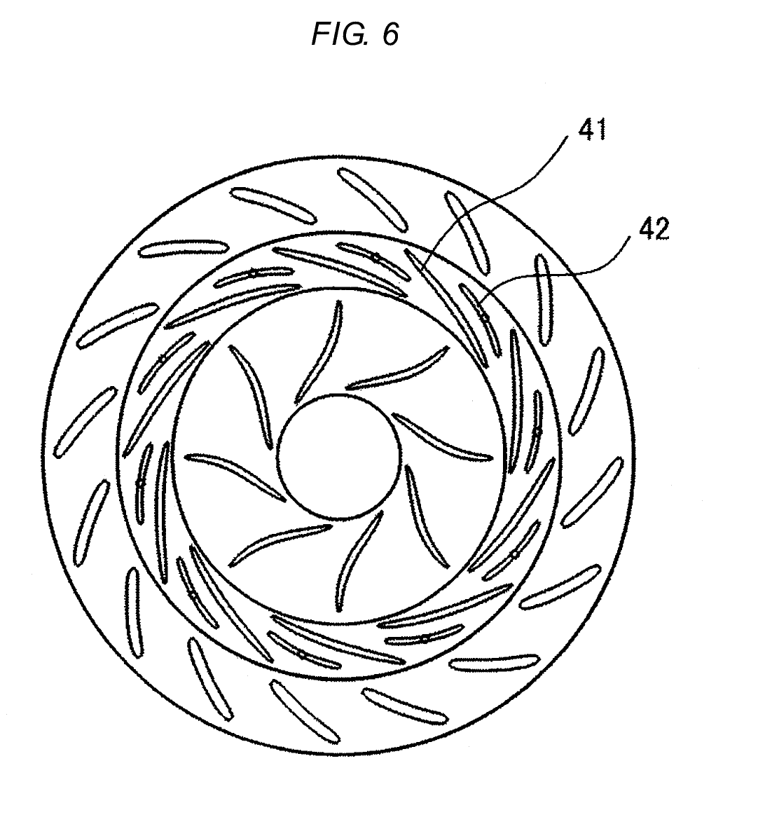

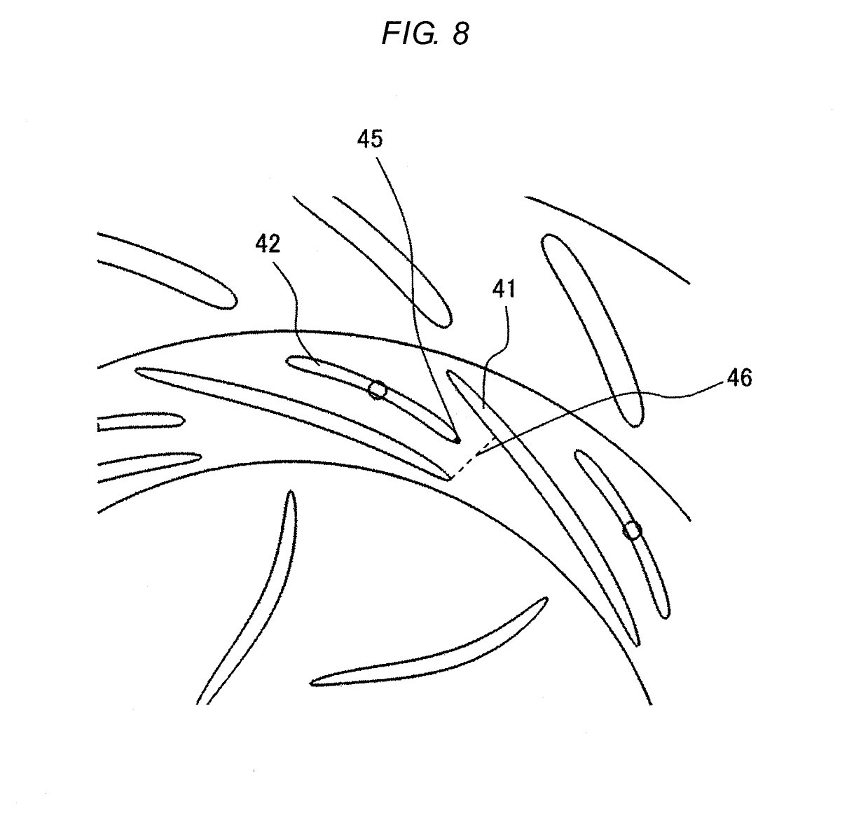

Another example of the invention will be illustrated in FIG. 6 to FIG. 8. In Example 2, in the same manner as Example 1 in FIG. 1, the thin guide vanes having different chord lengths are arranged alternately, and only the short vanes from among the guide vanes are configured to be movable. Then, Example 2 is characterized in that the short vanes are installed on the upstream sides of the flow channels in comparison with Example 1 in FIG. 1. In other words, as illustrated in FIG. 8, Example 2 is characterized in that rear ends 45 of the movable guide vanes 42 having the short chord length are positioned on the upstream sides of positions 46 where the distance between the vanes is a minimum in the flow channels configured by the adjacent fixed guide vanes 41 having the long chord length.

As Example 1, when the movable guide vanes 42 having the short chord length are installed in the vicinity of the positions 46 where the distance is a minimum between the fixed guide vanes 41 having the long chord length, the flow channels between the guide vanes maybe fully closed even when the chord length of the movable guide vanes is set to be extremely reduced, and hence it is advantageous conditions in terms of the strength with respect to the guide vanes.

However, since the angle of flow is small in the low flow rate condition, the ratio of the thickness of the vane with respect to the width of the flow channel is large, which is a condition in which the uniformity of the flow at the outlets of the guide vanes cannot be obtained easily. Under such a condition, it is much better off without a substance which may disturb the flow in the vicinity of the outlets of the guide vanes in view of the uniformity of the flow. At this point, the positions where the movable guide vanes are arranged and the distance between the fixed vanes is a minimum correspond to a rear end of one of the vanes of the fixed guide vanes in Example 1, and hence arrangement of the movable guide vanes at these positions is not preferable in view of the uniformity of the flowing field. Accordingly, in Example 2, the movable guide vanes having the short chord length are arranged so that the rear ends 45 are positioned on the upstream side of the positions 46 where the distance between the fixed vanes having the long chord length is a minimum.

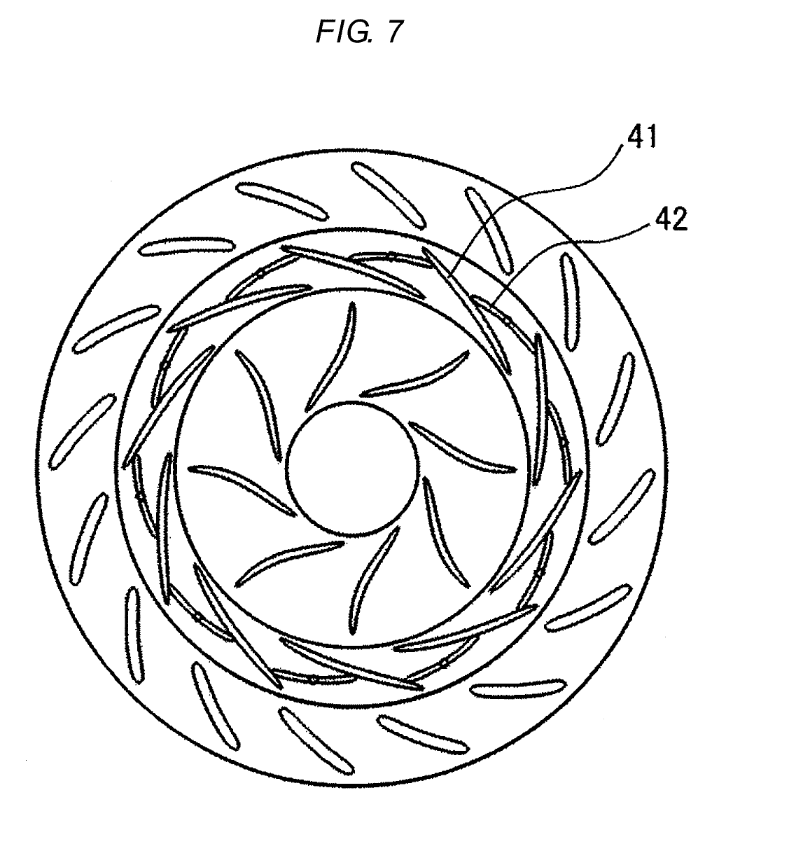

In this configuration, in order to fully close the flow channels with the movable guide vanes 42 having the short chord length as illustrated in FIG. 7, the vane cord length of the movable guide vanes is longer than that in Example 1. However, since the uniformity of the flowing field at the inlet of the runner is improved, efficiency of the hydroturbine higher than that in Example 1 is achieved.

The invention is not limited to Examples described above, and various modifications are included. For example, Examples described above are detailed explanation for facilitating the understanding of the invention, and the invention is not limited to those having all the configurations described above. Also, part of the configuration of one Example maybe replaced by those of other Examples, or the configurations of other Examples may be added to the configuration of one Example. Also, part of the configuration of each Example may be added with configurations of other Examples, may be eliminated therefrom, or may be replaced by configurations of other Examples.

For example, in Examples described above, the fixed guide vanes having the long chord length and the movable guide vanes having the short chord length are arranged alternately. However, two of the movable guide vanes having the short chord length may be arranged between the fixed guide vanes having the long chord length. In this case, although the structural complexity is increased, since the chord length of the movable guide vanes may further be reduced, further thinner movable guide vanes may be obtained, so that the improvement of the uniformity of the flow may be expected.

What is claimed is:

1. Hydroturbine guide vanes comprising:
a plurality of fixed guide vanes having a long chord length; and
a plurality of movable guide vanes having a short chord length arranged between the fixed guide vanes.

2. The hydroturbine guide vanes according to claim 1, wherein the fixed guide vanes and the movable guide vanes are arranged alternately.

3. The hydroturbine guide vanes according to claim 2, wherein the fixed guide vanes are overlapped with the adjacent fixed guide vanes in angle areas in the direction of rotation of the hydroturbine.

4. The hydroturbine guide vanes according to claim 1, wherein rear ends of the movable guide vanes are positioned on the upstream side of the positions where the distance between the fixed guide vanes is a minimum.

5. A hydroturbine comprising: a spiral casing; stay vanes; guide vanes; and a runner, wherein the guide vanes are installed separately from the stay vanes, and the hydroturbine guide vanes according to claim 1 are used as the guide vanes.

6. A hydroturbine comprising: a spiral casing; stay vanes; guide vanes; and a runner, wherein the guide vanes are installed separately from the stay vanes, and the hydroturbine guide vanes according to claim 2 are used as the guide vanes.

7. A hydroturbine comprising: a spiral casing; stay vanes; guide vanes; and a runner, wherein the guide vanes are installed separately from the stay vanes, and the hydroturbine guide vanes according to claim 3 are used as the guide vanes.

8. A hydroturbine comprising: a spiral casing; stay vanes; guide vanes; and a runner, wherein the guide vanes are installed separately from the stay vanes, and the hydroturbine guide vanes according to claim 4 are used as the guide vanes.
